(19) United States
(12) Patent Application Publication
(10) Pub. No.: US 2007/0025558 A1
(43) Pub. Date: Feb. 1, 2007

(54) Audio device maintenance support apparatus

(75) Inventor: Takeshi Sakai, Hamamatsu-shi (JP)

Correspondence Address: HARNESS, DICKEY & PIERCE, P.L.C., P.O. BOX 828, BLOOMFIELD HILLS, MI, 48303, US

(73) Assignee: Yamaha Corporation, Hamamatsu-shi (JP)

(21) Appl. No.: 11/491,452

(22) Filed: Jul. 21, 2006

(30) Foreign Application Priority Data
Jul. 29, 2005 (JP) 2005-220323

(51) Int. Cl. H04R 29/00

(52) U.S. Cl. 381/59

(57) ABSTRACT

An audio device maintenance support apparatus which is capable of notifying a user in advance of timing for loudspeaker unit replacement. An audio signal is input via a signal input section. An amplifier amplifies the input audio signal. A loudspeaker unit outputs the audio signal amplified by the amplifier, as sound. An integral value calculating section calculates an integral value of the signal level of the audio signal supplied to the loudspeaker unit via the amplifier with respect to a supply time length of the audio signal. When the calculated integral value exceeds a predetermined threshold value, a notification control section gives a message recommending maintenance of the loudspeaker unit.

### BACKGROUND OF THE INVENTION

1. Field of the Invention

The present invention relates to an audio device maintenance support apparatus, and more particularly to a technique for improving efficiency in the maintenance of a loudspeaker.

2. Description of the Related Art

FIG. 5 is a schematic diagram of a general loudspeaker unit. A frame 52 is rigidly secured to an edge of an opening of a casing 51 appearing in FIG. 5, and a magnetic circuit 53 comprised of a permanent magnet is secured to a bottom part of the frame 52. Further, the magnetic circuit 53 is provided with a voice coil 54 wound in a direction substantially perpendicular to a magnetic field. The voice coil 54 is secured to a back surface of a bottom part of a diaphragm 56 mounted to the frame 52 via an edge 55 in a stretched manner, and the opposite ends of the voice coil 54 are connected to an amplifier, not shown, by a signal line 57. When an audio signal amplified by the amplifier is supplied to the voice coil 54 through the signal line 57, the diaphragm 56 vertically vibrates due to electromagnetic induction caused by the audio signal, whereby a sound wave is output (see Japanese Laid-Open Patent Publication (Kokai) No. H09-200894 for details of the construction of a loudspeaker).

In general, failure or malfunction of a loudspeaker unit occurs due to degradation of the performance of a specific part, such as a voice coil or an edge. Therefore, if the loudspeaker unit is replaced with a new one, on an as-needed basis, before expiration of the service life of such a specific part, it is possible to prevent occurrence of failure. However, it is very difficult for the user of a loudspeaker unit to manage the service lives of such specific parts, and hence these parts are left unattended until failure occurs. This can cause failure of the loudspeaker unit, on such an occasion as a live event, in which occurrence of failure is not allowed. Meanwhile, it is considered that timing in which loudspeaker unit replacement is necessitated can be substantially accurately predicted based on the length of time spent on reproduction, and other conditions.

### SUMMARY OF THE INVENTION

It is an object of the present invention to provide an audio device maintenance support apparatus which is capable of notifying the user in advance of timing for loudspeaker unit replacement.

To attain the above object, in a first aspect of the present invention, there is provided an audio device maintenance support apparatus comprising an input device via which an audio signal is input, an amplifier that amplifies the input audio signal, a sounding device that outputs the audio signal amplified by the amplifier, as sound, a calculation device that calculates an integral value of a signal level of the audio signal supplied to the sounding device via the amplifier with respect to supply time length of the audio signal, and a notification control device that is operable when the calculated integral value exceeds a predetermined threshold value, to give a message recommending maintenance of the sounding device.

Preferably, the predetermined threshold value includes a plurality of threshold values, and whenever the calculated integral value exceeds each of the threshold values, the notification control device gives a specific message associated with each threshold value and recommending maintenance of the sounding device.

Preferably, the audio device maintenance support apparatus further comprises a light-emitting element that emits light selectively in a plurality of colors, and the notification control device gives each of the specific messages by switching the light emitted from the light-emitting element from one color to another.

To attain the above object, in a second aspect of the present invention, there is provided an audio device maintenance support apparatus comprising an input device via which an audio signal is input, an amplifier that distributes the input audio signal and amplifies each of the distributed audio signals, a plurality of sounding devices that output the respective audio signals amplified by the amplifier, as sound, a calculation device that separately calculates respective integral values of signal levels of the audio signals supplied to the sounding devices via the amplifier with respect to supply time length of the audio signals, a determination device that is operable when an integral value calculated by the calculation device in association with the audio signal supplied to one of the sounding devices exceeds a predetermined threshold value, to determine whether or not an integral value calculated by the calculation device in association with the audio signal supplied to another of the sounding devices is below the threshold value, and a notification control device that is operable when the determination device determines that the integral value calculated by the calculation device in association with the audio signal supplied to the other sounding device is below the threshold value, to give a message recommending replacement of the one sounding device with the other sounding device.

To attain the above object, in a third aspect of the present invention, there is provided an audio device maintenance support apparatus comprising an input device via which an audio signal is input, an amplifier that distributes the input audio signal and amplifies each of the distributed audio signals, a plurality of sounding device groups each formed by a plurality of sounding devices that output the respective audio signals amplified by the amplifier, as sound, a calculation device that separately calculates integral values of signal levels of the audio signals supplied to the sounding device groups via the amplifier with respect to supply time length of the audio signals, a determination device that is operable when an integral value calculated by the calculation device in association with the audio signal supplied to one of the sounding device groups exceeds a predetermined threshold value, to determine whether or not an integral value calculated by the calculation device in association with the audio signal supplied to another of the sounding device groups is below the threshold value, and a notification control device that is operable when the determination device determines that the integral value calculated by the calculation device in association with the audio signal supplied to the other sounding device group is below the threshold value, to give a message recommending replacement of the one sounding device group with the other sounding device group.

According to the present invention, it is possible to notify a user in advance of timing for loudspeaker unit replacement, thereby enhancing maintenance efficiency and reducing a total cost required for maintenance.

The above and other objects, features, and advantages of the invention will become more apparent from the following detailed description taken in conjunction with the accompanying drawings.

### BRIEF DESCRIPTION OF THE DRAWINGS

FIG. 1 is a block diagram of the hardware configuration of a loudspeaker unit maintenance support system as an audio device maintenance support apparatus according to a first embodiment of the present invention;

FIG. 2 is a diagram of the data structure of a threshold value storage section of the loudspeaker unit maintenance support system shown in FIG. 1;

FIG. 3 is a diagram useful in explaining a method of calculating an integral value used in the loudspeaker unit maintenance support system shown in FIG. 1;

FIG. 4 is a block diagram of the hardware configuration of a loudspeaker unit maintenance support system as an audio device maintenance support apparatus according to a second embodiment of the present invention; and

FIG. 5 is a schematic diagram of a conventional loudspeaker unit.

### DETAILED DESCRIPTION OF THE PREFERRED EMBODIMENTS

The present invention will now be described in detail below with reference to the drawings showing preferred embodiments thereof.

First, a description will be given of a first embodiment of the present invention. The present embodiment has the following two characterizing features: One of the features is that an integral value of the signal level of an audio signal supplied to a loudspeaker unit with respect to a supply time length thereof is calculated, and when the calculated integral value exceeds a predetermined threshold value, an LED (Light Emitting Diode) is caused to emit light so as to notify the user of the arrival of timing for replacement. It is generally known that occurrence of failure or malfunction of a loudspeaker unit or degradation of the performance of the loudspeaker unit is dependent on the supply time length of an audio signal supplied to the loudspeaker unit, i.e. the use time length of the device. However, in the case of the audio device, particularly the loudspeaker unit, electrical or mechanical load applied to the specific parts, such as the voice coil or the edge, differs largely depending on the signal level (sound pressure level) of the audio signal reproduced. Conventionally, the level of the audio signal for reproduction has been grasped using a UV meter or a peak meter provided in an audio control console or a power amplifier. However, these are only capable of indicating the signal level of the audio signal supplied during a relatively short time period. Therefore, there has existed no means for monitoring the signal level of the audio signal supplied over a relatively long time period, and supplying the signal for prediction of occurrence of failure of the audio device or degradation of the performance of the device. In view of this problem, the present invention makes it possible to combine the two physical indicators, i.e. the signal level (sound pressure level) and supply time of the audio signal, each of which can indicate a degree of adverse influence causing failure of the device or degradation of its performance, to thereby enable assessment of the possibility of failure of the device or the degree of degradation of its performance using the one physical indicator, i.e. the combined physical indicator. The other feature of the present embodiment is that threshold values with reference to which is determined whether conditions for illuminating an LED are satisfied are provided in three levels, and when the calculated integral value sequentially exceeds the threshold values, the LED is caused to emit light selectively in different colors set in a manner associated with the respective threshold values. This configuration is provided in view of a problem that when failure occurs abruptly, there is no choice but to cope with the failure in an ex post facto manner, and it is made possible to stepwise indicate the probability of occurrence of failure or malfunction of the loudspeaker unit or the degree of degradation of the performance of the loudspeaker unit by associating the threshold values with the respective different LED illuminating states, as described above.

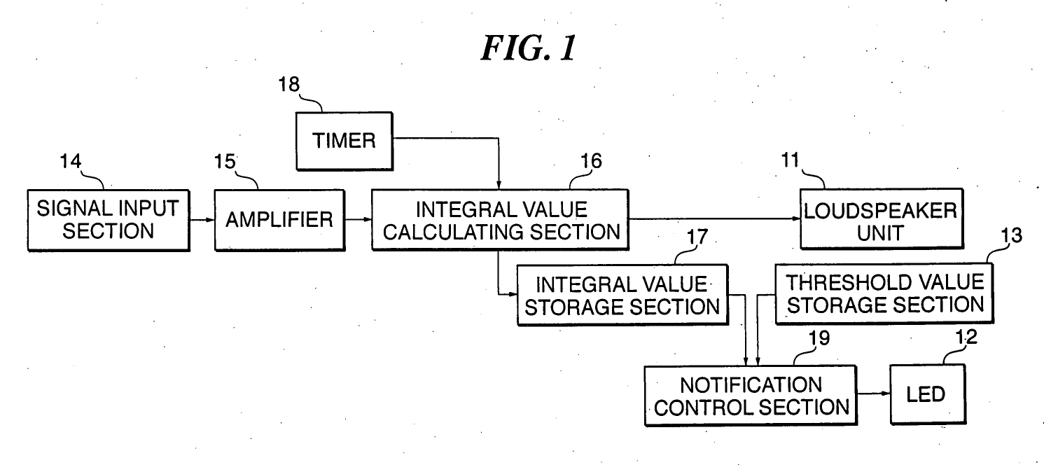

FIG. 1 is a block diagram of the hardware configuration of a loudspeaker unit maintenance support system as an audio device maintenance support apparatus according to the present embodiment. As shown in FIG. 1, the present system is comprised of a loudspeaker unit 11, an LED 12, a threshold value storage section 13, a signal input section 14, an amplifier 15, an integral value calculating section 16, an integral value storage section 17, a timer 18, and a notification control section 19.

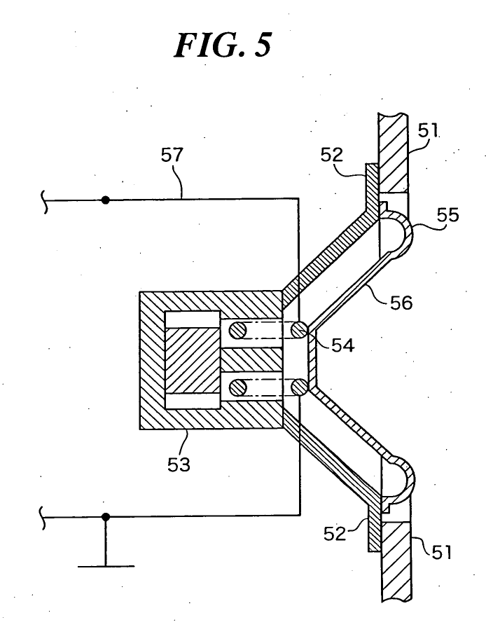

The construction of the loudspeaker unit 11 is the same as that of the conventional loudspeaker unit shown in FIG. 5, and therefore duplicate description thereof is omitted. The LED 12 is a light emitting element that selectively emits light in three colors, such as blue, purple, and red. The LED 12 is embedded in the vicinity of the loudspeaker unit 11.

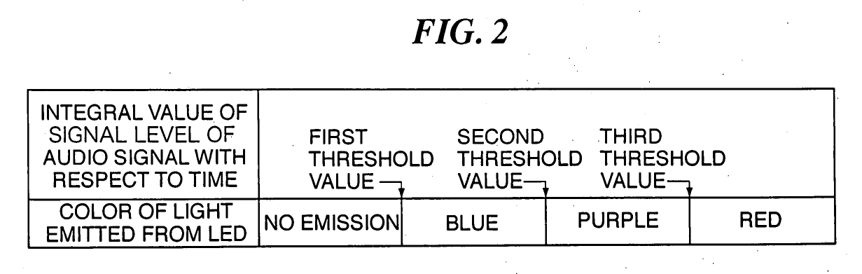

The threshold value storage section 13 is a nonvolatile memory, and stores first to third threshold values for use as conditions for illuminating the LED 12, and the colors of lights to be selectively emitted from the LED 12 when the respective conditions are satisfied, in association with each other. FIG. 2 is a diagram showing an example of the structure of data stored in the threshold value storage section 13. As described at the beginning of this description, in the present embodiment, the threshold values for use as conditions for illuminating the LED 12 are provided in three levels. FIG. 2 shows that the LED 12 is caused to emit blue light when the integral value of the signal level of an audio signal with respect to the supply time length of the audio signal becomes larger than the first threshold value, purple light when the same becomes larger than the second threshold value, and red light when the same becomes larger than the third threshold value. It should be noted that each of the threshold values is set based on statistics of occurrences of failure of loudspeaker units 11 of the same model in the past. For example, an integral value corresponding to a statistical fact that failure occurred in 90% of the loudspeaker units 11 of the same model is set to the third threshold value, an integral value corresponding to a statistical fact that failure occurred in 70% of the loudspeaker units 11 to the second threshold value, and an integral value corresponding to a statistical fact that failure occurred in 50% of the loudspeaker units 11 to the first threshold value.

Referring to FIG. 1, the signal input section 14 is an interface via which an audio signal is input e.g. from a sound source. The audio signal input via the signal input section 14 is amplified by the amplifier 15, and then supplied to the loudspeaker unit 11 via the integral value calculating section 16. The loudspeaker unit 11 outputs the received audio signal as sound.

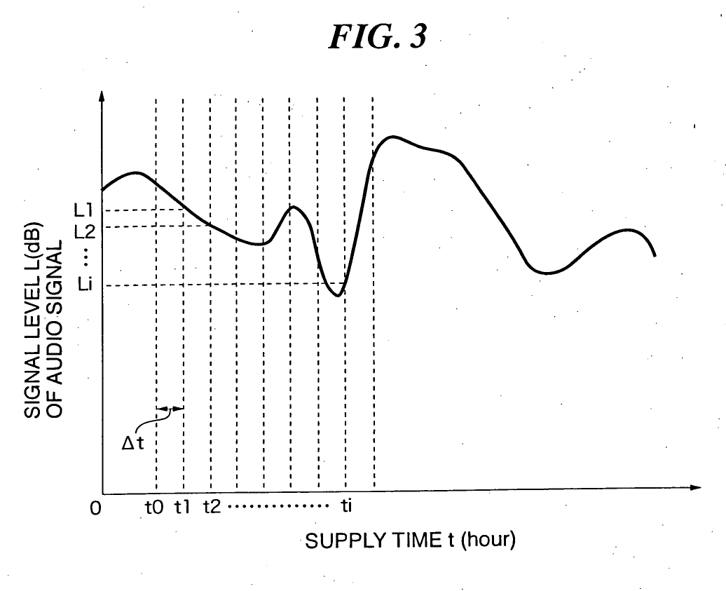

The integral value storage section 17 is a nonvolatile memory, and stores the integral value of the signal level of the audio signal supplied to the loudspeaker unit 11 from the amplifier 15 with respect to the supply time length of the audio signal. The integral value stored in the integral value storage section 17 is updated by the integral value calculating section 16. Now, how the integral value stored in the integral value storage section 17 is updated by the integral value calculating section 16 will be described with reference to FIG. 3. FIG. 3 is a diagram of the waveform of an audio signal passing through the integral value calculating section 16 over a certain time length. With the aid of the timer 18, the integral value calculating section 16 detects a signal level Li of the waveform of the audio signal passing therethrough, whenever a predetermined extraction time interval Δt elapses, and cumulatively adds the product of the detected signal level Li and the extraction time interval Δt to the value stored as the cumulative value of the product in the integral value storage section 17. For example, as illustrated in FIG. 3, at time t1, the product of the current signal level L1 of the audio signal and the extraction time interval Δt is added to the integral value stored in the integral value storage section 17, and at time t2, the product of a signal level L2 of the audio signal and the extraction time interval Δt is further added. Although the signal level of the audio signal is normally expressed in decibels, it is converted into an energy value for calculation of the integral value. For convenience of calculation, however, dB values may be used instead.

Referring again to FIG. 1, when the value stored in the integral value storage section 17 is updated, the notification control section 19 determines whether or not the updated value has exceeded any of the threshold values set in the threshold value storage section 13. If one of the threshold values has been exceeded, a signal for giving an instruction for emitting light in a color associated with the exceeded threshold value in the threshold value storage section 13 is delivered to the LED 12. In response to the received signal, the LED 12 emits light in the color designated by the signal.

According to the above described embodiment, the user is urged through light emitted by the LED 12 to replace the loudspeaker unit 11 with a new one, which enables the user to replace the loudspeaker unit 11 with the new one before occurrence of failure, and hence failure of the loudspeaker unit can be prevented before it occurs. This makes it possible to prevent an accident due to such failure from occurring in a commercial show or the like, thereby enabling a business risk to be avoided. Further, by switching the color of the light emitted from the LED 12, it is possible to stepwise notify the user of the arrival of timing for replacement of the loudspeaker unit 11 with a new one. This makes it possible to conduct intensive and scheduled maintenance of loudspeaker units or like device using the present system in predetermined timing, which contributes to reduction of a total cost required for loudspeaker unit maintenance.

Next, a description will be given of a second embodiment of the present invention.

The loudspeaker unit maintenance support system as the audio device maintenance support apparatus according to the first embodiment includes the single loudspeaker unit, and notifies the user through light emitted by the LED 12 of the necessity of replacement of the loudspeaker unit with a new one. As is distinct therefrom, the loudspeaker unit maintenance support system as an audio device maintenance support apparatus according to the present embodiment includes a plurality of loudspeaker units as a loudspeaker array, and calculates the respective integral values of the signal levels of audio signals supplied to the loudspeaker units with respect to the supply time length of the audio signals. Thereafter, the loudspeaker unit maintenance support system recommends replacement of a loudspeaker unit as to which a larger integral value has been calculated by a loudspeaker unit as to which a smaller integral value has been calculated, i.e. so-called rotation of the loudspeaker units, to thereby substantially level off the service lives of all the loudspeaker units.

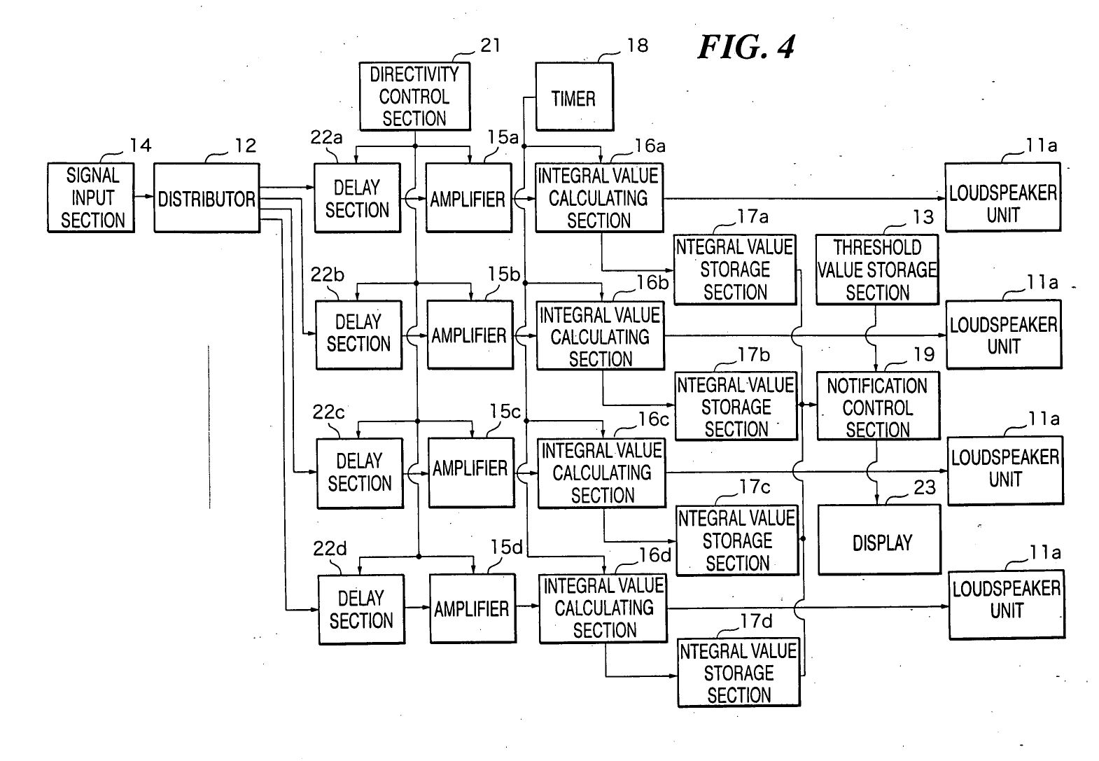

FIG. 4 is a block diagram of the hardware configuration of the loudspeaker unit maintenance support system as the audio device maintenance support apparatus according to the present embodiment. The present system is comprised of loudspeaker units 11a to 11d, the threshold value storage section 13, the signal input section 14, amplifiers 15a to 15d, integral value calculating sections 16a to 16d, integral value storage sections 17a to 17d, the notification control section 19, a distributor 20, a directivity control section 21, delay sections 22a to 22d, and a display 23. In the present embodiment, the loudspeaker units 11a to 11d are arranged in a row to form a loudspeaker array, and provided with respective independent signal processing systems formed by arranging the delay sections 22a to 22d, the amplifiers 15a to 15d, and the integral value calculating sections 16a to 16d in respective lines. Now, a description will be given of the outline of operation of each block shown in FIG. 4. The distributor 20 distributes an audio signal input via the signal input section 14 to the delay sections 22a to 22d. More specifically, the distributor 20 distributes a plurality of audio signals each of which has the same waveform as the input audio signal to the respective delay sections 22a to 22d. The distributed audio signals are subjected to delay processing by the respective delay sections 22a to 22d and amplification processing by the respective amplifiers 15a to 15d, and then delivered to the respective loudspeaker units 11a to 11d through the respective integral value calculating section 16a to 16d.

The directivity control section 21 controls the amounts of delay and amplification of each of the audio signals to be delivered to the respective loudspeaker units 11a to 11d. This causes audio beams having directivity in a desired direction to be output from the loudspeaker units 11a to 11d. The principle of audio beam acquisition belongs to the category of well known art, and hence description thereof is omitted.

Each of the integral value calculating sections 16a to 16d updates a value stored in a corresponding one of the integral value storage sections 17a to 17d associated with the respective loudspeaker units 11a to 11d, following the same procedure as described with reference to FIG. 3.

The notification control section 19 monitors an integral value stored in each of the integral value storage sections 17a to 17d, and when the integral value stored in one of the integral value storage sections 17a to 17d exceeds one of the first to third threshold values set in the threshold value storage section 13, the notification control section 19 determines whether or not any other integral value storage section 17 stores an integral value smaller than the integral value having exceeded the threshold value. If it is determined that another integral value storage section 17 stores a smaller integral value, the notification control section 19 causes the display 23 to display a message recommending replacement of the loudspeaker units 11 associated with the respective two integral value storage sections 17 with each other.

As described above, according to the present embodiment, when an integral value stored in one of the integral value storage sections 17a to 17d associated with the respective loudspeaker units 11a to 11d exceeds one of the threshold values, it is determined whether or not any other integral value storage section 17 stores an integral value smaller than the integral value having exceeded the threshold value. Then, if it is determined that another integral value storage section 17 stores a smaller integral value, a message recommending replacement of the loudspeaker units 11 associated with the respective two integral value storage sections 17 with each other is displayed on the display 23. Therefore, it is possible to substantially level off the service lives of all the loudspeaker units, thereby delaying timing for loudspeaker unit replacement. Further, since the loudspeaker units can be intensively or collectively replaced with new ones, it is possible to reduce a total cost required for maintenance.

The present invention is not limited to the above described embodiments, and can be practiced in various forms.

In the first embodiment, light emission by the LED 12 is used for notifying the user of the necessity of replacement of the loudspeaker unit 11 with a new one, and in the second embodiment, a message is displayed on the display 23 for notification of the necessity of replacement of loudspeaker units 11 with each other. Insofar as the use of the LED 12 is concerned, the color configuration of the LED 12 is not limited to the example described in the first embodiment, but a different color configuration may be set as desired by the user. Further, emission of light for notification is only required to be performed by one or more LEDs. More specifically, one or more LEDs may be used to emit lights for notifying the user of respective statuses associated with a plurality of threshold values. Furthermore, a device, such as a sounding device for outputting alarm sound, may be used in place of the LED 12 or the display 23. In short, any means can be employed insofar as it is capable of notifying the user of the arrival of timing for loudspeaker unit maintenance.

According to the loudspeaker unit maintenance support system of the second embodiment, the respective integral values of the signal levels of audio signals supplied to the respective loudspeaker units which form the loudspeaker array with respect to the supply time length of the audio signals are calculated, and when one of the calculated integral values exceeds a threshold value, a message recommending replacement of the associated loudspeaker unit 11 with another loudspeaker unit 11 as to which a smaller integral value has been calculated. However, the loudspeaker unit maintenance support system may be provided with a plurality of loudspeaker arrays and configured such that integral values are calculated in association with the respective loudspeaker arrays. In this case, when one of the calculated integral values associated with the respective loudspeaker arrays exceeds a threshold value, a message recommending replacement of the loudspeaker array associated with the calculated integral value exceeding the threshold value with another loudspeaker array as to which a smaller integral value has been calculated may be displayed. In short, a loudspeaker array as a set of loudspeaker units 11 may be regarded as a single “sounding means”, and replacement of loudspeaker arrays with each other may be recommended.

What is claimed is:

1. An audio device maintenance support apparatus comprising:
an input device via which an audio signal is input;
an amplifier that amplifies the input audio signal;
a sounding device that outputs the audio signal amplified by said amplifier, as sound;
a calculation device that calculates an integral value of a signal level of the audio signal supplied to said sounding device via said amplifier with respect to supply time length of the audio signal; and
a notification control device that is operable when the calculated integral value exceeds a predetermined threshold value, to give a message recommending maintenance of said sounding device.

2. An audio device maintenance support apparatus as claimed in claim 1, wherein the predetermined threshold value includes a plurality of threshold values, and
wherein whenever the calculated integral value exceeds each of the threshold values, said notification control device gives a specific message associated with each threshold value and recommending maintenance of said sounding device.

3. An audio device maintenance support apparatus as claimed in claim 2, further comprising a light-emitting element that emits light selectively in a plurality of colors, and
wherein said notification control device gives each of the specific messages by switching the light emitted from said light-emitting element from one color to another.

4. An audio device maintenance support apparatus comprising:
an input device via which an audio signal is input;
an amplifier that distributes the input audio signal and amplifies each of the distributed audio signals;
a plurality of sounding devices that output the respective audio signals amplified by said amplifier, as sound;
a calculation device that separately calculates respective integral values of signal levels of the audio signals supplied to said sounding devices via said amplifier with respect to supply time length of the audio signals;
a determination device that is operable when an integral value calculated by said calculation device in association with the audio signal supplied to one of said sounding devices exceeds a predetermined threshold value, to determine whether or not an integral value calculated by said calculation device in association with the audio signal supplied to another of said sounding devices is below the threshold value; and
a notification control device that is operable when said determination device determines that the integral value calculated by said calculation device in association with the audio signal supplied to said other sounding device is below the threshold value, to give a message recommending replacement of said one sounding device with said other sounding device.

5. An audio device maintenance support apparatus comprising:
an input device via which an audio signal is input;
an amplifier that distributes the input audio signal and amplifies each of the distributed audio signals;
a plurality of sounding device groups each formed by a plurality of sounding devices that output the respective audio signals amplified by said amplifier, as sound;
a calculation device that separately calculates integral values of signal levels of the audio signals supplied to said sounding device groups via said amplifier with respect to supply time length of the audio signals;
a determination device that is operable when an integral value calculated by said calculation device in association with the audio signal supplied to one of said sounding device groups exceeds a predetermined threshold value, to determine whether or not an integral value calculated by said calculation device in association with the audio signal supplied to another of said sounding device groups is below the threshold value; and
a notification control device that is operable when said determination device determines that the integral value calculated by said calculation device in association with the audio signal supplied to said other sounding device group is below the threshold value, to give a message recommending replacement of said one sounding device group with said other sounding device group.
